(19) United States
(12) Patent Application Publication
(10) Pub. No.: US 2011/0255194 A1
(43) Pub. Date: Oct. 20, 2011

(54) Elastic member structure of magnetic head

(75) Inventors: Chun-Wei Kuan, Zhonghe City (TW); Yi-Hsiung Lo, Zhonghe City (TW); Kai-Yu Cheng, Taipei (TW)

(73) Assignee: CASTLES TECHNOLOGY CO., LTD., Hsin-Tien (TW)

(21) Appl. No.: 12/761,404

(22) Filed: Apr. 16, 2010

(51) Int. Cl. G11B 5/48

(52) U.S. Cl. 360/240; G9B/5.147

(57) ABSTRACT

An improved elastic member structure of a magnetic head comprises: a base having a first and a second holder plates, a first through hole being formed on the first holder plate, and a gap being formed between the first and second holder plates; a fixing base plate being fixed onto the first holder plate and having a second through hole formed at the center, and the two sides of the second through hole comprising a third through hole respectively; an engaging elastic member being disposed onto the fixing base plate and having a fourth through hole formed at the center, and both ends of the engaging elastic member are passed through the third through holes respectively for fixing the engaging elastic member onto the fixed base plate; and a magnetic head module being passed into the first, second and fourth through holes for contacting a card and reading data.

### BACKGROUND OF THE INVENTION

1. Field of the Invention

The present invention relates to an elastic member structure of a magnetic head, and more particularly to an improved structure of a magnetic head with a fixing way.

2. Description of the Related Art

Using a magnetic card for a financial transaction such as making a payment or transferring money has become an integral part of our daily life. Other applications of the magnetic cards including door security control and personal identification are also used extensively, and thus a magnetic head fixing structure of a card reader for reading data from a magnetic strip of the magnetic card becomes more important as the scope of applicability of the magnetic card becomes broader.

When a magnetic head of the card reader reads data from the magnetic strip, the magnetic head and the magnetic strip must be attached closely with each other before the magnetic head can read the data from the magnetic strip effectively, and thus the magnetic head must be coupled to an elastic element, and the elasticity of the elastic element can provide an appropriate moving distance for the magnetic head to move with respect to the thickness of the magnetic card, so that when the magnetic card is passed through the magnetic head, the magnetic head is pushed by the magnetic card to produce an elastic restoring force, and the magnetic head is attached closely to the magnetic strip for reading the data stored in the magnetic strip. If the magnetic head and the magnetic strip are attached too closely or not closely enough, then the friction produced by sliding the magnetic strip through the magnetic head may damage the magnetic head and the magnetic strip easily or cause a failure of reading data.

With reference to FIGS. 1 and 2 for an exploded view and a perspective view of a conventional fixing structure of a magnetic head of a card reader, the magnetic head A10 is fixed at the center of a elastic member A11, and a circular hole A12 and a rectangular hole A13 are formed at both ends of the elastic member A11 respectively, and two screws A14, A15 are used for locking the elastic member A11 onto a base A16, and the magnetic head A10 is exposed from a slide groove A17, so that when a user inserts a card into the slide groove A17, the magnetic head A10 will be in contact with a magnetic strip of the card for reading data, and the magnetic head A10 will be pushed and displaced by the card, and the elastic member A11 will be displaced together with the magnetic head, and the circular hole A12 acts as a fixing end and the rectangular hole A13 acts as a pressing end to produce a deformation in an arc shape, and the rectangular hole A13 appropriately provides a contractible space for the displacement of the ends during the arc deformation of the elastic member A11, so as to prevent the magnetic head A10 from being rigidity contacted to the magnetic strip and avoid excessive wearing or poor reading.

However, the elastic member of the conventional magnetic head is fixed directly onto the base by a screw connection or soldering method. Although the screw connection and soldering methods are simple, easily and cost saving, yet it takes more time and labor to remove the screws or the solder for maintaining, repairing or replacing the magnetic head or the elastic member of the magnetic head, and these are the major drawbacks of a fixed magnetic head.

Furthermore, the conventional way of fixing the elastic member of the magnetic head onto the base by the screw connection method usually produces non-uniform locking pressure and results in a poor reading of data or even a damage of components.

In view of the drawbacks of the prior art, it has to provide an improved elastic member structure of a magnetic head to improve the level of simplicity and convenience of installing or removing the elastic member of the magnetic head.

### SUMMARY OF THE INVENTION

The inventor of the present invention based on years of experience in the related industry to conduct extensive researches and experiments, and finally developed an improved elastic member structure of a magnetic head.

The primary objective of the present invention is to provide an improved elastic member structure of a magnetic head that provides a secured connection of the elastic member and the magnetic head and simple and easy installation and removal by means of improving the connection of related components.

Another objective of the present invention is to provide an improved elastic member structure of a magnetic head that increases the stability of the structure to prevent any displacement or structural deformation when a card is read.

A further objective of the present invention is to provide an improved elastic member structure of a magnetic head that includes an engaging elastic member for stabilizing the pressure of connecting the magnetic head module to improve the card reading efficiency and prevent poor data reading.

To achieve the foregoing objective, the present invention provides an improved elastic member structure of a magnetic head, comprising: a base, including a first holder plate, and a first through hole formed on the base; a second holder plate, with a side coupled to a side of the first holder plate, and a gap being formed between the first holder plate and the second holder plate for passing through a card to read the card; a fixing base plate, being fixed onto a surface of the first holder plate opposite to the one adjacent to the second holder plate, and both sides of the fixing base plate having a protrusion separately, and the two protrusions being bent and protruded toward the direction opposite to the one that the fixing base plate connected to the first holder plate, wherein the two protrusions and the central area of the fixing base plate are disposed on different planes, and the fixing base plate including a second through hole formed at the center, and the size and position of the second through hole correspond to the first through hole of the first holder plate, and both sides of the second through hole having a third through hole separately, and the range of forming the third through holes are extended to an edge of the protrusion; an engaging elastic member, being disposed onto a surface of the fixing base plate opposite to the one adjacent to the first holder plate, wherein both ends of the engaging elastic member are passed into the third through holes respectively, and a portion of the passed end is placed between the protrusion of the fixing base plate and the first holder plate, and the engaging elastic member includes a fourth through hole formed at the center, and the size and position of the fourth through hole correspond to the first through hole of the first holder plate and the second through hole of the fixing base plate; and a magnetic head module, being passed into the first through hole, the second through hole and the fourth through hole, and a portion of a surface of the magnetic head module is exposed from the gap between the first holder plate and the second holder plate for contacting with a card and reading data.

### BRIEF DESCRIPTION OF THE DRAWINGS

FIG. 1 is an exploded view of a conventional fixing structure of a magnetic head of a card reader;

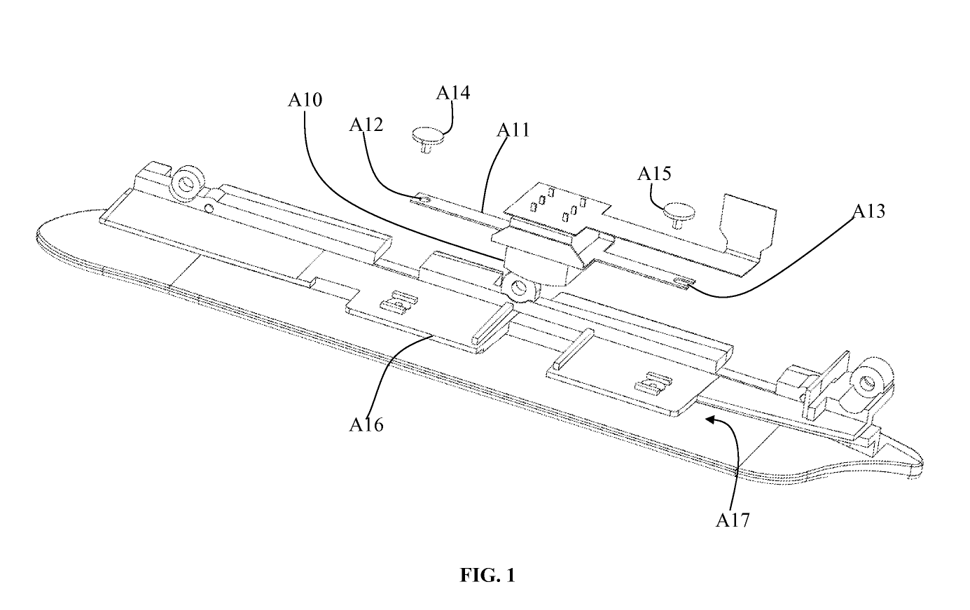

FIG. 2 is a perspective view of a conventional fixing structure of a magnetic head of a card reader;

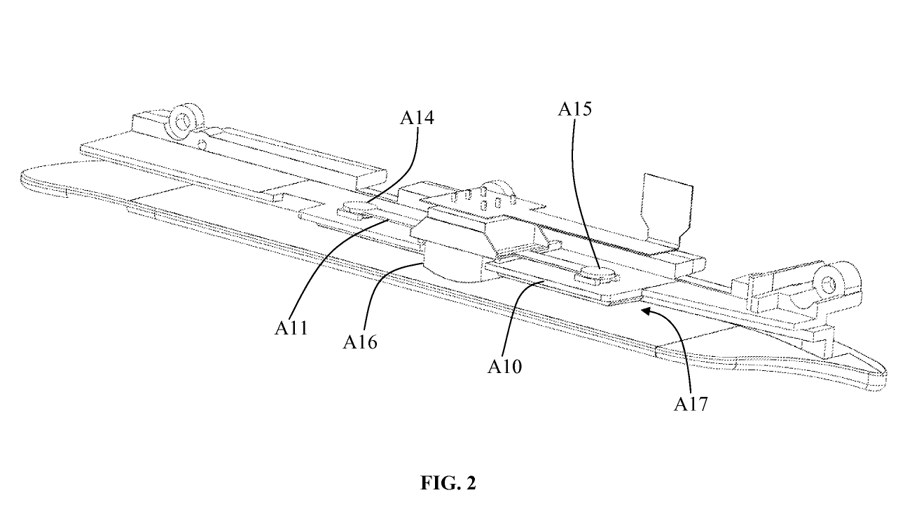

FIG. 3 is an exploded view of an improved elastic member structure of a magnetic head in accordance with a first preferred embodiment of the present invention;

FIG. 4 is a perspective view of the improved elastic member structure of the magnetic head in accordance with the first preferred embodiment of the present invention;

FIG. 5 is an exploded view of the improved elastic member structure including a fixing base plate, an engaging elastic member and a magnetic head module in accordance with the first preferred embodiment of the present invention with another viewing angle;

FIG. 6 is a perspective view of the improved elastic member structure including the fixing base plate, the engaging elastic member and the magnetic head module of the magnetic head in accordance with the first preferred embodiment of the present invention with another viewing angle;

FIG. 7 is an exploded view of the improved elastic member structure of the magnetic head in accordance with a second preferred embodiment of the present invention;

FIG. 8 is an exploded view of the improved elastic member structure including the fixing base plate, the engaging elastic member and the magnetic head module in accordance with the second preferred embodiment of the present invention with another viewing angle; and

FIG. 9 is a perspective view of the improved elastic member structure including the fixing base plate, the engaging elastic member and the magnetic head module of the magnetic head in accordance with the second preferred embodiment of the present invention with another viewing angle.

### DETAILED DESCRIPTION OF THE PREFERRED EMBODIMENTS

The structural assembly, overall operation and technical characteristics of the present invention will become apparent with the detailed description of the preferred embodiments and the illustration of the related drawings as follows.

To achieve the foregoing objectives and effects, the inventor of the present invention adopts a fixing base plate together with an elastic member of a magnetic head, and uses a passing and engaging method for connecting them, and constantly makes adjustments and corrections to obtain an improved elastic member structure of a magnetic head in accordance with the present invention. The overall structure and technical characteristics of an improved elastic member structure of a magnetic head in accordance with the present invention will be demonstrated by first and second preferred embodiments as follows.

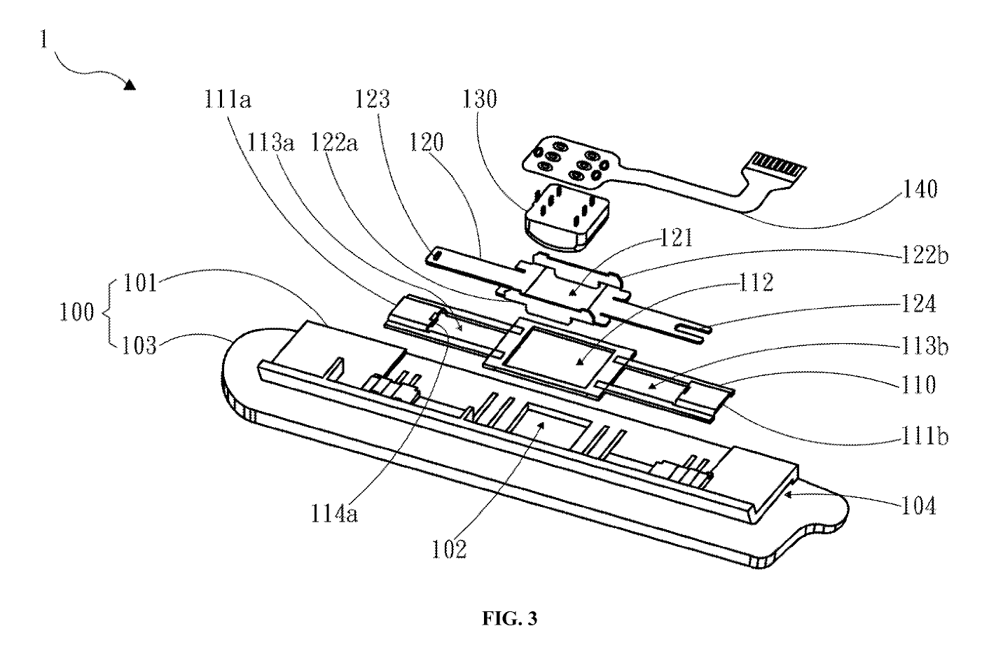

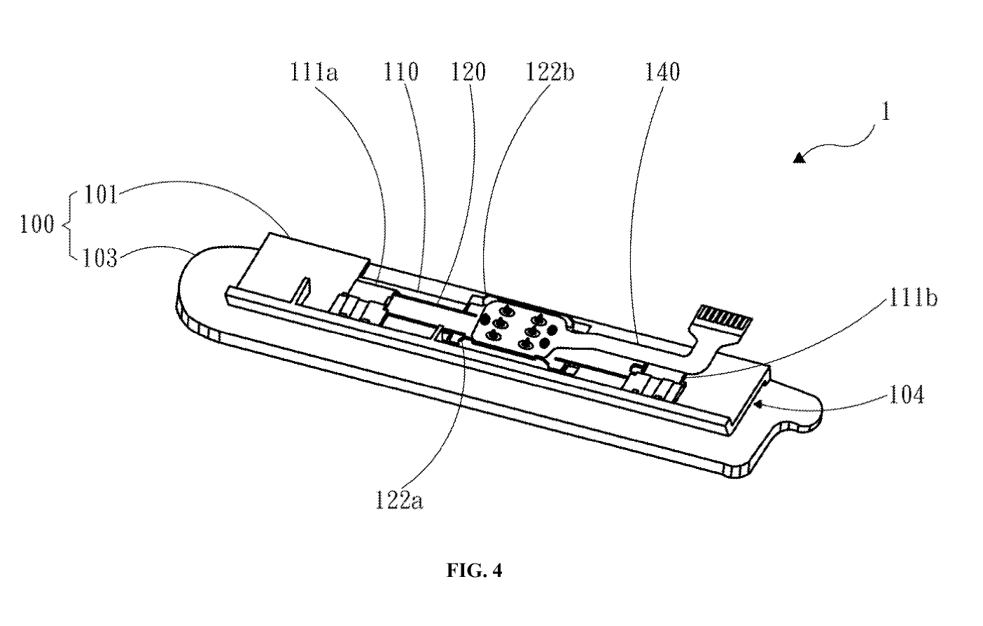

With reference to FIGS. 3 and 4 for an exploded view and a perspective view of an improved elastic member structure of a magnetic head in accordance with the first preferred embodiment of the present invention respectively, the improved elastic member structure of a magnetic head 1 includes:

a base 100, including: a first holder plate 101, including a first through hole 102 formed thereon; and a second holder plate 103, having a side coupled to a side of the first holder plate 101, and a gap 104 being formed between the first holder plate 101 and the second holder plate 103 for passing a card and reading data;

a fixing base plate 110, being fixed on a surface of the first holder plate 101 opposite to the one adjacent to the second holder plate 103, and two protrusions 111a, 111b being formed separately on both sides of the fixing base plate 110, wherein the two protrusions 111a, 111b are bent and protruded toward a direction opposite to the one of connecting the fixing base plate 110 with the first holder plate 101, and the two protrusions 111a, 111b and the central area of the fixing base plate 110 are disposed on different planes, and the central area of the fixing base plate 110 includes a second through hole 112, and the size and position of the second through hole 112 are correspond to those of the first through hole 102 of the first holder plate 101, and two third through holes 113a, 113b are formed separately on both sides of the second through hole 112, and the range of forming the third through hole 113a, 113b is extended to an edge of the protrusion 111a, 111b;

an engaging elastic member 120, being disposed onto a surface of the fixing base plate 110 opposite to the one adjacent to the first holder plate 101, wherein both ends of the engaging elastic member 120 are passed into the third through holes 113a, 113b respectively, and the passed portion is placed between the protrusion 111a, 111b of the fixing base plate 110 and the first holder plate 101, and a fourth through hole 121 formed at the center of the engaging elastic member 120, and the size and position of the fourth through hole 121 correspond to those of the first through hole 102 of the first holder plate 101 and the second through hole 112 of the fixing base plate 110;

a magnetic head module 130, being passed into the first through hole 102, the second through hole 112 and the fourth through hole 121, wherein a partial surface of the magnetic head module 130 is exposed from the gap 104 between the first holder plate 101 and the second holder plate 103 for contacting a card and reading data; and

an electrically conductive plate 140, being electrically coupled to the magnetic head module 130 for transmitting data of the card read by the magnetic head module 130 to a specific electronic device, such as a printed circuit board and a central processing unit for processing data.

In the first preferred embodiment of the present invention, the fixing base plate 110 is fixed onto the first holder plate 101 by a screw connection. However, the fixing base plate 110 can be fixed onto the first holder plate 101 by a soldering or engaging method in a practical application.

In addition, two vertical stop plates 122a, 122b are installed separately on both sides of the fourth through hole 121 of the engaging elastic member 120, so that when the magnetic head module 130 is passed through the fourth through hole 121, the two stop plates 122a, 122b can be used for fixing the magnetic head module 130 into a fixed position and preventing them from being shaken and loosened.

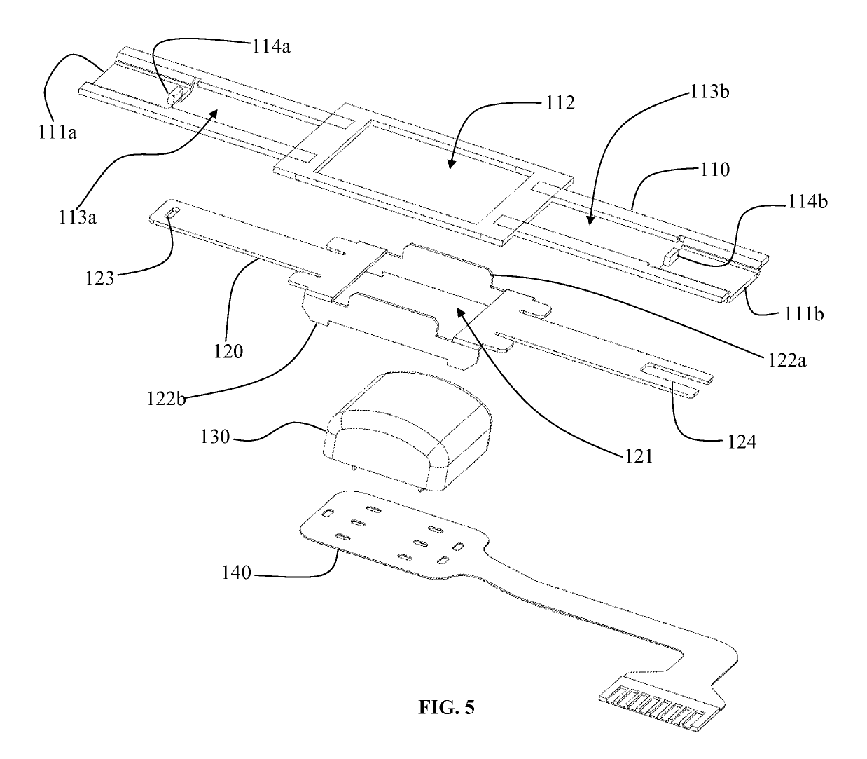

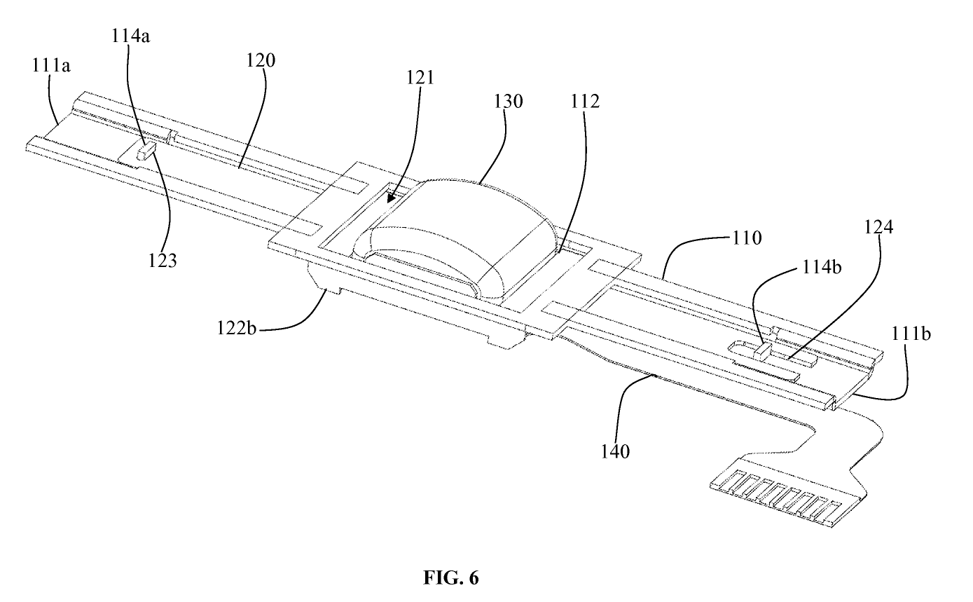

With reference to FIGS. 5 and 6 for another exploded view and a perspective view of the fixing base plate 110, the engaging elastic member 120 and the magnetic head module 130 in accordance with the first preferred embodiment of the present invention respectively, two protruding pillars 114a, 114b are disposed separately on two protrusions 111a, 111b of the fixing base plate 110 and on a surface facing towards the first holder plate 101 for fixing the engaging elastic member 120. On the other hand, a circular engaging through hole 123 is formed at an end of the engaging elastic member 120, and a rectangular positioning slot 124 formed at another end of the engaging elastic member 120, and when both ends of the engaging elastic member 120 are passed through the third through holes 113a, 113b, the engaging through holes 123 can be engaged with the protruding pillar 114a of the fixing base plate 110 to further enhance the stability of coupling the engaging elastic member 120 and the fixing base plate 110, and the positioning slot 124 and the protruding pillar 114b are loosely connected, so that when a card is in contact with a magnetic head module 130, the magnetic head module 130 and the engaging elastic member 120 will be propped up to a small distance. Now, the positioning slot 124 and the protruding pillar 114b will be displaced with respect to each other to produce a shock absorbing effect to provide a stable pressure, so as to avoid the structure of the engaging elastic member 120 from being deformed by the propping action.

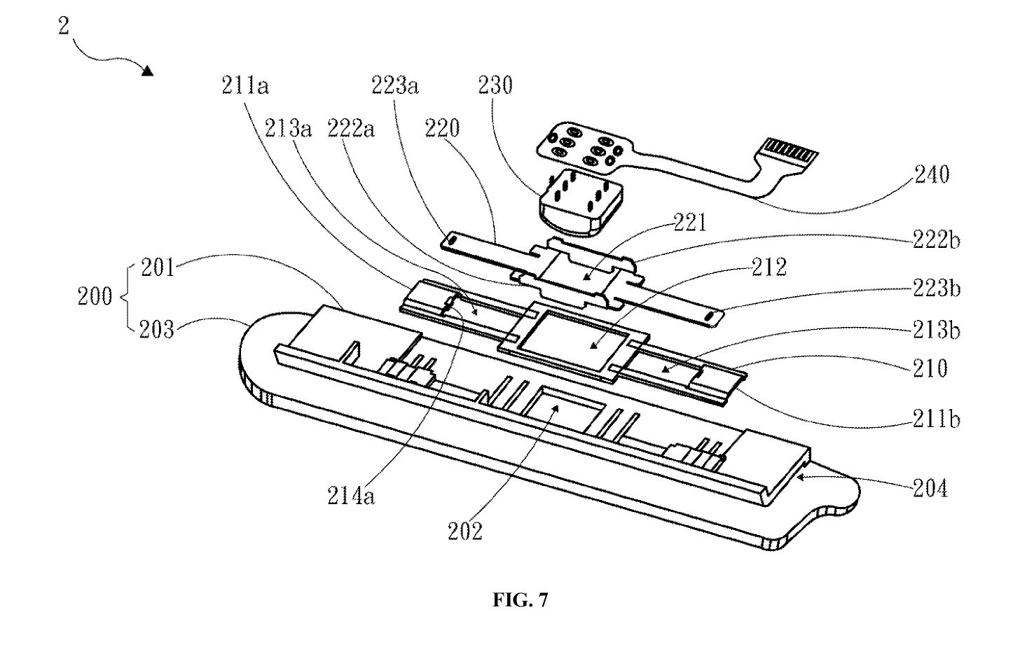

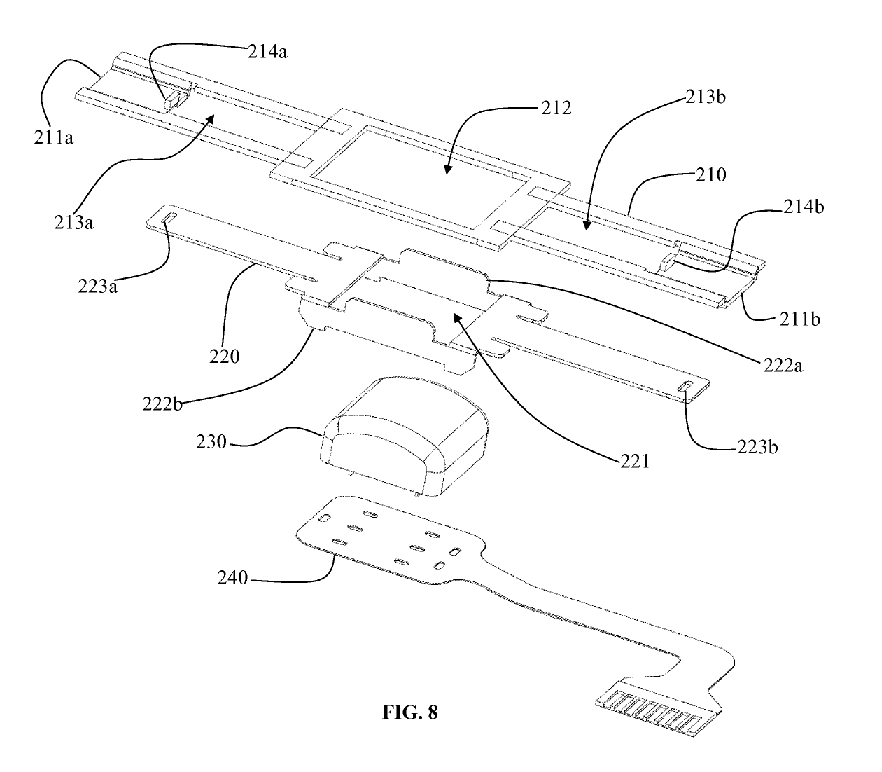

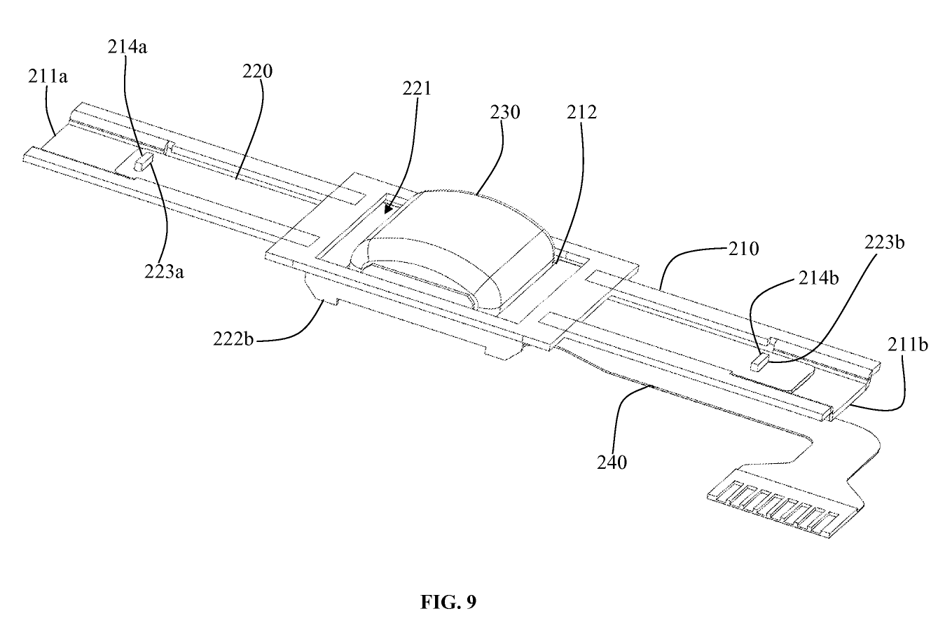

With reference to FIGS. 7 to 9, FIG. 7 is an exploded view of the improved elastic member structure of the magnetic head in accordance with the second preferred embodiment of the present invention, FIGS. 8 and 9 are an exploded view and a perspective view of a fixing base plate, an engaging elastic member and a magnetic head module in accordance with a second preferred embodiment of the present invention with another viewing angle, the improved elastic member structure of a magnetic head 2 comprises:

a base 200, comprising: a first holder plate 201, having a first through hole 202 formed thereon; a second holder plate 203, having a side coupled to a side of the first holder plate 201, and a gap 204 being formed between the first holder plate 201 and the second holder plate 203, for passing a card and reading data;

a fixing base plate 210, being fixed to the first holder plate 201 and on a surface opposite to the adjacently coupled second holder plate 203, and having two protrusions 211a, 211b disposed separately on both sides of the fixing base plate 210, and the two protrusions 211a, 211b are bent in a direction opposite to the direction of connecting the fixing base plate 210 with the first holder plate 201 and protruded, and the two protrusions 211a, 211b and the central area of the fixing base plate 210 are disposed on different planes, and a second through hole 212 is formed in the central area of the fixing base plate 210, and the size and position of the second through hole 212 correspond to those of the first through hole 202 of the first holder plate 201, and two third through holes 213a, 213b are formed separately on both sides of the second through hole 212, and the range of forming the third through hole 213a, 213b is extended to an edge of the protrusion 211a, 211b, and two protruding pillars 214a, 214b are disposed separately on a surface of the two protrusions 211a, 211b of the fixing base plate 210 facing the first holder plate 201;

an engaging elastic member 220, being disposed on a surface of the fixing base plate 210 opposite to the one adjacent to the first holder plate 201, wherein both ends of the engaging elastic member 220 are passed into the third through holes 213a, 213b respectively, and the passed portion is placed between the protrusions 211a, 211b of the fixing base plate 210 and the first holder plate 201, and a fourth through hole 221 is formed at the center of the engaging elastic member 220, and the size and position of the fourth through hole 221 correspond to those of the first through hole 202 of the first holder plate 201 and the second through hole 212 of the fixing base plate 210;

a magnetic head module 230, being passed into the first through hole 202, the second through hole 212 and the fourth through hole 221, and a partial surface of the magnetic head module 230 is exposed from the gap 204 between the first holder plate 201 and the second holder plate 203 for contacting a card and reading data; and

an electrically conductive plate 240, being electrically coupled to the magnetic head module 230, for transmitting data of the card read by the magnetic head module 230 to a specific electronic device such as a printed circuit board and a central processing unit for processing data.

In the second preferred embodiment of the present invention, the fixing base plate 210 is fixed onto the first holder plate 201 by a screw connection. However, the fixing base plate 210 can be fixed onto the first holder plate 201 by a soldering or engaging method in a practical application.

In addition, two vertical stop plates 222a, 222b are installed separately on both sides of the fourth through hole 221 of the engaging elastic member 220, so that when the magnetic head module 230 is passed through the fourth through hole 221, the two stop plates 222a, 222b can be used for fixing the magnetic head module 230 into a fixed position and preventing them from being shaken and loosened.

The main difference between the second preferred embodiment and the first preferred embodiment resides on that a engaging through hole 223a, 223b is formed separately at both ends of the engaging elastic member 220 of the second preferred embodiment, so that when both ends of the engaging elastic member 220 are passed into the third through holes 213a, 213b respectively, the engaging through hole 223a, 223b of the engaging elastic member 220 can be engaged with the protruding pillar 214a, 214b of the fixing base plate 210 to further improve the stability of coupling the engaging elastic member 220 to the fixing base plate 210. Although the second preferred embodiment does not come with a positioning slot (as indicated by 122 of the first preferred embodiment in FIG. 3), and cannot have a displacement with respect to the protruding pillar 214a, 214b to achieve a shock absorbing effect, various different flexible and extendible materials are well developed and can be used for making the engaging elastic member 220, so that the deformation caused by the displacement can be reduced effectively, and the worn-out and damage of the magnetic head module 230 or the card can be avoided. In addition, the structure of devices can reduce assembling and positioning defects and provide an easy control of the elasticity.

In summation, the overall structure and technical characteristics of an improved elastic member structure of a magnetic head in accordance with the present invention has the following advantages:

The present invention makes use of the connection between the fixing base plate and the engaging elastic member to achieve the effect of an insert-to-connect relation between the fixing base plate and the engaging elastic member without using the screw connection method, so that when the engaging elastic member or the magnetic head module are removed for a repair or replacement, users simply need to release the insert-to-connect relation between the fixing base plate and the engaging elastic member. Compared with the prior art that requires unscrewing the engaging elastic member, the present invention is time-saving, labor-saving and easy-to-install.

In the first preferred embodiment of the present invention, the positioning slot is formed on the engaging elastic member and loosely connected to the protruding pillar of the fixing base plate, so that when the magnetic head module is in contact with a card, the magnetic head module and the engaging elastic member will have a small displacement, and the positioning slot and the protruding pillar will be displaced with respect to each other. This arrangement can avoid the with respect to from being deformed by rigidity and prevent the magnetic head module or the with respect to from being damaged.

The engaging method adopted in the present invention can couple the with respect to and the magnetic head module to avoid the non-uniform pressure caused by the screw connection of the prior art, so as to provide s stable pressure for coupling the magnetic head module to improve the efficiency of reading cards.

What is claimed is:

1. An improved elastic member structure of a magnetic head, comprising:
a base, comprising:
a first holder plate, having a first through hole formed thereon; and
a second holder plate, with a side coupled to a corresponding side of the first holder plate, and a gap being formed between the first holder plate and the second holder plate for passing and reading a card;
a fixing base plate, being fixed onto a surface of the first holder plate opposite to the one adjacent to the second holder plate, and both sides of the fixing base plate having a protrusion respectively, and the two protrusions being bent and protruded toward the direction opposite to the direction of connecting the fixing base plate with the first holder plate, and the two protrusions and a central area of the fixing base plate being disposed on different planes, and a second through hole being formed at the center of the fixing base plate, and the second through hole having dimensions and a position corresponding to those of the first through hole of the first holder plate, and both sides of the second through hole having a third through hole respectively, and the third through holes having a range extended to an edge of the protrusion;
an engaging elastic member, being disposed onto a surface of the fixing base plate opposite to the one adjacent to the first holder plate, and both ends of the engaging elastic member passing into the third through holes respectively, and the passed portion being placed between the protrusion of the fixing base plate and the first holder plate, and a fourth through hole being formed at the center of the engaging elastic member, and the fourth through hole having a size and a position corresponding to those of the first through hole of the first holder plate and the second through hole of the fixing base plate; and
a magnetic head module, being passed into the first through hole, the second through hole and the fourth through hole, and a partial surface of the magnetic head module being exposed from the gap between the first holder plate and the second holder plate for contacting a card and reading data.

2. The improved elastic member structure of a magnetic head according to claim 1, further comprising an electrically conductive plate electrically coupled to the magnetic head module for transmitting data obtained from reading the card by the magnetic head module to a specific electronic device and processing the data.

3. The improved elastic member structure of a magnetic head according to claim 1, wherein the fixing base plate is fixed onto the first holder plate through screw.

4. The improved elastic member structure of a magnetic head according to claim 1, wherein the fixing base plate is fixed onto the first holder plate by soldering.

5. The improved elastic member structure of a magnetic head according to claim 1, wherein the fixing base plate is fixed onto the first holder plate by engaging.

6. The improved elastic member structure of a magnetic head according to claim 1, wherein the surfaces of the two protrusions of the fixing base plate towards the first holder plate are disposed with a protruding pillar for positioning the engaging elastic member.

7. The improved elastic member structure of a magnetic head according to claim 6, wherein the two ends of the engaging elastic member comprises an engaging through hole separately, so that when both ends of the engaging elastic member are passed through the third through hole, the engaging elastic member can be engaged to the protruding pillar by the engaging through hole to enhance the stability of coupling the engaging elastic member with the fixing base plate.

8. The improved elastic member structure of a magnetic head according to claim 6, wherein one end of the engaging elastic member comprises an engaging through hole and another end of the engaging elastic member comprises a positioning slot, so that when both ends of the engaging elastic member are passed into the third through holes respectively, the engaging through hole can be engaged with the protruding pillar on the fixing base plate to further improve the stability of coupling the engaging elastic member with the fixing base plate, and the positioning slot being loosely coupled with the protruding pillar for propping the magnetic head module and the engaging elastic member to a small distance when a card is contacted with the magnetic head module, so that the positioning slot is displaced with respect to the protruding pillar to provide a shock absorbing effect to avoid the structure of the engaging elastic member from being deformed by the propping.

9. The improved elastic member structure of a magnetic head according to claim 1, wherein the two ends of the fourth through hole of the engaging elastic member comprises a vertical stop plate respectively, so that when the magnetic head module is passed through the fourth through hole, the two stop plates can position the magnetic head module and prevent the magnetic head module from being shaken or loosened.
